(19) United States
(12) Patent Application Publication
(10) Pub. No.: US 2025/0195189 A1
(43) Pub. Date: Jun. 19, 2025

(54) ORAL CARE DEVICE

(71) Applicant: GUANGZHOU STARS PULSE CO., LTD., GUANGZHOU (CN)

(72) Inventors: SHENGBIN WU, GUANGZHOU (CN); HUIXIANG HUANG, GUANGZHOU (CN)

(21) Appl. No.: 18/927,105

(22) Filed: Oct. 25, 2024

(30) Foreign Application Priority Data
Dec. 15, 2023 (CN) 202323453944.8

(51) Int. Cl. A61C 17/22

(52) U.S. Cl. CPC A61C 17/225

(57) ABSTRACT

An oral care device includes a hand-held shell, a circuit board, a communication assembly, and an electrical connector. The hand-held shell defines a signaling portion. The circuit board is disposed inside the hand-held shell. The communication assembly is disposed inside the hand-held shell. The communication assembly includes a communication module, and the communication module is disposed on and electrically connected to the circuit board. The electrical connector is disposed inside the hand-held shell. The communication module is electrically connected to the signaling portion of the hand-held shell via the electrical connector. The signaling portion of the hand-held shell and the communication module jointly form a signal transceiver. The signal transceiver is configured to send signals to an exterior of the hand-held shell and/or receive signals from the exterior of the hand-held shell.

### TECHNICAL FIELD

The present disclosure relates to a field of oral cleaning, and in particular to an oral care device.

### BACKGROUND

An oral care device is an electric device that is configured with a motor having a high vibration speed to drive a brush head to rotate or vibrate to clean teeth. According to user demands, an antenna, which is configured to send signals and/or receive signals, is disposed in the oral care device to send operation information to a control terminal or a cloud; or to receive commands sent from the control terminal or the cloud. However, when a conventional antenna disposed in the oral care device sends and/or receives the signals, the signals need to penetrate internal structures or a housing of the oral care device, resulting in loss in the signals and a poor transmission efficiency.

### SUMMARY OF THE DISCLOSURE

The present disclosure provides an oral care device to solve a technical problem that a conventional antenna disposed inside the oral care device has poor transmission efficiency.

In a first aspect, the present disclosure provides an oral care device including a hand-held shell, a circuit board, a communication assembly, and an electrical connector. The hand-held shell defines a signaling portion. The circuit board is disposed inside the hand-held shell. The communication assembly is disposed inside the hand-held shell. The communication assembly includes a communication module, and the communication module is disposed on and electrically connected to the circuit board. The electrical connector is disposed inside the hand-held shell. The communication module is electrically connected to the signaling portion of the hand-held shell via the electrical connector. The signaling portion of the hand-held shell and the communication module jointly form a signal transceiver. The signal transceiver is configured to send signals to an exterior of the hand-held shell and/or receive signals sent from the exterior of the hand-held shell.

In a second aspect, the present disclosure provides an oral care device including: a hand-held shell, a communication assembly, and an electrical connector. The hand-held shell defines a signaling portion. The communication assembly is disposed inside the hand-held shell. The communication assembly includes a communication module. The electrical connector is disposed inside the hand-held shell. The communication module is electrically connected to the signaling portion of the hand-held shell via the electrical connector. The signaling portion of the hand-held shell and the communication module jointly forms a signal transceiver. The signal transceiver is configured to send signals to an exterior of the hand-held shell and/or to receive signals sent from the exterior of the hand-held shell.

Since the communication module is electrically connected to the signaling portion of the hand-held shell, the communication module and the signaling portion of the hand-held shell jointly form the signal transceiver. In this case, the signals sent by the signal transceiver are directly transmitted to the exterior of the hand-held shell via the signaling portion of the hand-held shell, and the signals sent by an external device are directly received by the signaling portion of the hand-held shell. The signals do not need to penetrate the hand-held shell during transmission, the loss in the signals is reduced, and the transmission efficiency of the signals is improved.

### BRIEF DESCRIPTION OF THE DRAWINGS

The above additional aspects and characteristics of the present disclosure will be apparent and readily understood based on the description of the embodiments referring to the following accompanying drawings.

FIG. 1 is a perspective schematic diagram of an oral care device according to some embodiments of the present disclosure.

FIG. 2 is a partial exploded schematic diagram of the oral care device shown in FIG. 1.

FIG. 3 is a cross-sectional schematic diagram of the oral care device shown in FIG. 1.

FIG. 4 is an enlarged schematic diagram of a portion IV shown in FIG. 3.

FIG. 5 is a partial enlarged diagram of the oral care device according to some embodiments of the present disclosure.

FIG. 6 is a perspective schematic diagram of the oral care device according to some other embodiments of the present disclosure.

FIG. 7 is a partial enlarged schematic diagram of the oral care device according to some embodiments of the present disclosure.

FIG. 8 is a partial enlarged diagram of the oral care device according to some embodiments of the present disclosure.

FIG. 9 is a partial enlarged diagram of the oral care device according to some embodiments of the present disclosure.

FIG. 10 is a partial enlarged diagram of the oral care device according to some embodiments of the present disclosure.

Reference numerals in the drawings:
100—oral care device; A—center axis; X—direction of the center axis of the hand-held shell; Y—direction perpendicular to the center axis of the hand-held shell; H0—length of the hand-held shell; H1—distance between the signaling portion and the top of the hand-held shell; H2—distance between the signaling portion and the bottom of the hand-held shell; 10—hand-held shell; 101—signaling portion; 103—non-signalizing portion; 11—hand-held portion; 111—top end of the hand-held portion; 113—bottom end of the hand-held portion; 13—bottom cover; 1301—abutting piece; 131—blocking portion; 133—connection portion; 20—circuit board; 21—protruding portion; 30—communication assembly; 31—communication module; 40—electrical connector; 41—first end of the electrical connector; 43—second end of the electrical connector; 50—inner liner; 60—movement assembly.

### DETAILED DESCRIPTION

Embodiments of the present disclosure are described in detail below, and examples of the embodiments are shown in the accompanying drawings. Same or similar reference numerals denote same or similar elements or elements having same or similar functions.

In the description herein, it is understood that the terms “thickness”, “top”, “top”, “bottom”, “inside”, “outside”, and so on, indicate orientations or positional relationships based on those shown in the accompanying drawings and are used only for the purpose of description and for simplifying the description. The terms do not indicate or imply that a device or an element must have the particular orientations or must be configured and operated at the particular orientations. Therefore, the terms shall not be interpreted as a limitation of the present disclosure. Furthermore, the terms “first” and “second” are used only for descriptive purposes and shall not be interpreted as indicating or implying relative importance or implicitly specifying the number of technical features. A feature defined by the terms “first” and “second” may expressly or impliedly include one or more features. In the description herein, “a plurality of” means two or more, unless otherwise expressly and specifically limited.

In the description herein, it is to be noted that, unless otherwise expressly provided and qualified, the terms “mounted”, “connected”, “coupled” shall be understood in a broad sense, and in an example, connection may be fixed connection, or detachable connection, or integrally connected to form a one-piece structure; or mechanical connection, or electrical connection, or communicative connection; or direct connection, or indirect connection through an intermediate medium, or connection internally within two elements, or an interaction between the two elements.

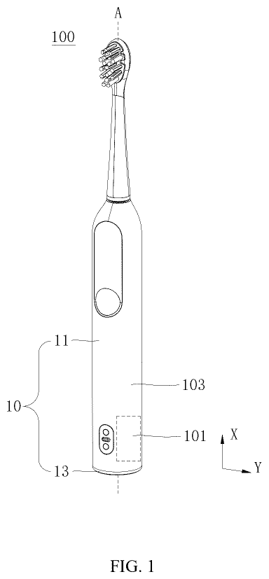

As shown in FIGS. 1, 2, and 4, the present disclosure provides an oral care device 100, including a hand-held shell 10, a circuit board 20 disposed inside the hand-held shell 10, a communication assembly 30 disposed inside the hand-held shell 10, and an electrical connector 40 disposed inside the hand-held shell 10. The hand-held shell 10 defines a signaling portion 101. The communication assembly 30 includes a communication module 31, which is disposed on and electrically connected to the circuit board 20. The communication module 31 is electrically connected to the signaling portion 101 of the hand-held shell 10 via the electrical connector 40. The signaling portion 101 of the hand-held shell 10 and the communication module 31 jointly form a signal transceiver. The signal transceiver is configured to send signals to an exterior of the hand-held shell 10 and/or receive external signals sent from the exterior of the hand-held shell 10.

In the oral care device 100 of the present disclosure, after the communication module 31 is electrically connected to the signaling portion 101 of the hand-held shell 10, the communication module 31 and the signaling portion 101 of the hand-held shell 10 jointly form the signal transceiver. In this case, the signals sent by the signal transceiver are directly transmitted to the exterior of the hand-held shell 10 via the signaling portion 101 of the hand-held shell 10, and the external signals sent by an external device are directly received by the signaling portion 101 of the hand-held shell 10. The signals do not need to penetrate the hand-held shell 10 during transmission, and therefore, a loss of the signals is reduced, and a transmission efficiency of the signals is improved.

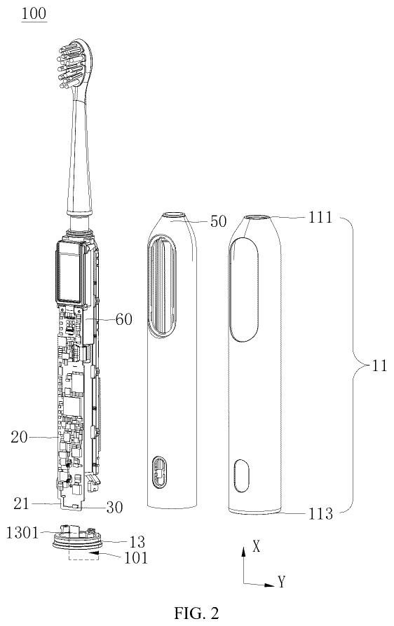

As shown in FIGS. 1 and 2, in some embodiments, the hand-held shell 10 is substantially a housing that accommodates partial structures of the oral care device 100. The partial structures of the oral care device 100 are disposed inside the hand-held shell 10. The hand-held shell 10 is made of, but not limited to, a metal or an alloy. The communication module 31 disposed inside the hand-held shell 10 is electrically connected to the signaling portion 101 disposed on the hand-held shell 10. In this way, a current from the communication module 31 is converted into the signals by the signaling portion 101, and the signals are directly transmitted outwardly. Alternatively, externals signal received by the signaling portion 101 are converted into a current that can be recognized by the communication module 31. Therefore, the loss of the signals, caused by the signals passing through the hand-held shell 10, can be reduced.

Specifically, in some embodiments, the hand-held shell 10 includes a top end and a bottom end opposite to the top end. The hand-held shell 10 has a center axis A. The center axis A of the hand-held shell 10 is an axis that divides the hand-held shell 10 into two portions symmetrical to each other. In a case that the hand-held shell 10 is a three-dimensional structure symmetrical about the center axis A, the center axis A of the hand-held shell 10 extends through a center of the top end of the hand-held shell 10 and a center of the bottom end of the hand-held shell 10. That is, an extending direction X of the center axis A of the hand-held shell 10 is either a direction of a straight line extending from the center of the top end of the hand-held shell 10 to the center of the bottom end of the handle shell 10, or a direction of the straight line extending from the center of the bottom end of the hand-held shell 10 to the center of the top end of the hand-held shell 10, which is not limited herein. A direction Y perpendicular to the center axis A of the hand-held shell 10 may be a direction of a straight line extending between any two opposite sides of the hand-held shell 10, which is not limited herein. A shape of outer contours of cross sections of the hand-held shell 10 is, but not limited to, right circular, oval, triangular, quadrangular, pentagonal, etc. In some embodiments, along the direction X of the center axis A of the hand-held shell 10, from the bottom end of the hand-held shell 10 to the top end of the hand-held shell 10, sizes of the outer contours of the cross sections of the hand-held shell 10 gradually change. For example, the sizes of the outer contours of the cross sections of the hand-held shell 10 firstly remains constant, and then gradually decreases; or firstly increases and then decreases; or changes for a plurality of times. In other embodiments, along the direction X of the center axis A of the hand-held shell 10, from the bottom end of the hand-held shell 10 to the top end of the hand-held shell 10, the sizes of the outer contours of the cross sections of the hand-held shell 10 remain constant.

More specifically, in some embodiments, the hand-held shell 10 includes a hand-held portion 11 and a bottom cover 13. The hand-held portion 11 is substantially cylindrical. The hand-held portion 11 includes the top end 111 (i.e., the top end of the hand-held shell 10) and the bottom end 113 (i.e., the bottom end of the hand-held shell 10) opposite to the top end 111. The bottom end of the hand-held portion 11 has an opening, and the partial structures of the oral care device 100 extend, from the opening, to the interior of the hand-held portion 11 and are mounted inside the hand-held portion 11. The bottom cover 13 is mounted to the bottom end 113 of the hand-held portion 11 and is located at the opening to seal the opening, preventing external dust, steam, liquid or foam from entering the hand-held portion 11. Therefore, the partial structures of the oral care device 100 disposed inside the hand-held portion 11 are prevented from being damaged. In some embodiments, at least part of the hand-held portion 11 and the bottom cover 13 are made of metal. Materials of the hand-held portion 11 and the bottom cover 13 include, but are not limited to, aluminum, iron, and alloys thereof. In some embodiments, at least part of the hand-held portion 11 and the bottom cover 13 are non-metallic, and in this case, the materials of the hand-held portion 11 and the bottom cover 13 include, but are not limited to, plastic, silicone, or rubber, etc.

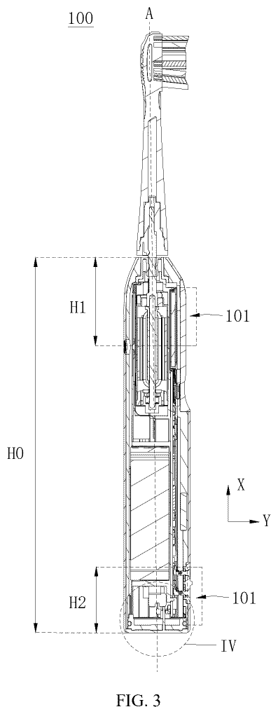

Further, as shown in FIG. 3, in some implementations, the signaling portion 101 is configured to transform a high-frequency current or guided waves sent by the communication module 31 into radio waves or free electromagnetic waves and to radiate the radio waves or the free electromagnetic waves to a surrounding space to generate a large radiation field. In addition, the signaling portion 101 is further configured to receive radio waves or free electromagnetic waves sent from an external terminal or a cloud and to transform the received radio waves or the received free electromagnetic waves into a current or guided waves that can be recognized by the communication module 31. In some embodiments, the signaling portion 101 is made of an antenna material. The antenna material include, but are not limited to, metals, ceramics, or fiberglass. Compared to other materials of conductors, when the antenna material is applied, a distance over which the signals emitted by the signaling portion 101 are transmitted is greatly increased, signal transmission is highly stably. In this way, the signaling portion 101 can receive signals from a wider range, and information obtained from the received signals is more complete.

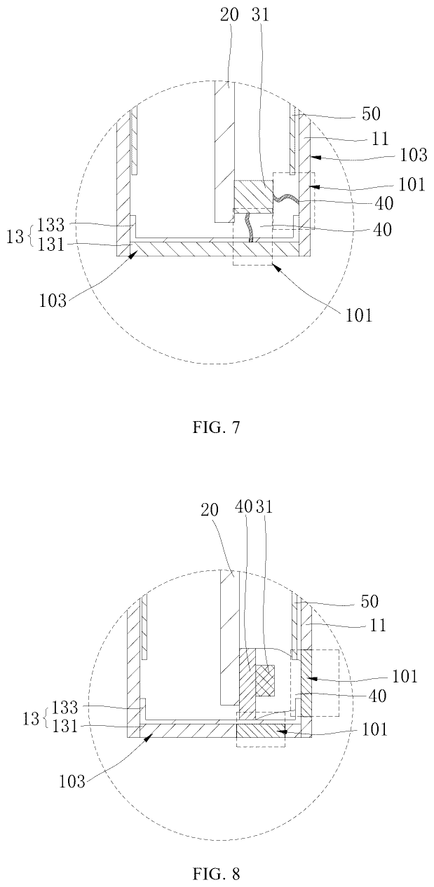

Specifically, as shown in FIGS. 2, 4 and 6, in some embodiments, the signaling portion 101 is disposed on the bottom cover 13. A first end of the electrical connector 40 is electrically connected to the communication module 31 to transmit the electric current or the guided waves. A second end of the electrical connector 40 abuts against the signaling portion 101 on the bottom cover 13 to transmit the electric current or the guided waves to the signaling portion 101 on the bottom cover 13. In the case that the signaling portion 101 is disposed on the bottom cover 13, the signals are directly transmitted outwardly through the signaling portion 101 at the bottom cover 13; or the external signals from the external device are received by the signaling portion 101 at the bottom cover 13. In this case, a signal transmitting and receiving region corresponding to the signaling portion 101 is completely located within the bottom cover 13. In this way, an influence, caused by structures of the oral care device 100, on the signal transmitting and receiving through the antenna is reduced, ensuring quality of signal transmission and signal strength. In some other embodiments, as shown in FIG. 1, the signaling portion 101 is located on the hand-held portion 11. The first end of the electrical connector 40 is electrically connected to the communication module 31 to transmit the current or the guided waves, and the second end of the electrical connector 40 abuts against the signaling portion101 on the hand-held portion 11 to transmit the current or the guided waves to the signaling portion 101 on the hand-held portion 11. In the case that the signaling portion 101 is disposed on the hand-held portion 11, the signaling portion 101 may be located at any position on the hand-held portion 11. In this case, the electrical connector 40 may be a wire that is disposed inside the hand-held portion 11 and is connected to the communication module 31 on the circuit board 20 and the signaling portion 101. The signaling portion 101 located at any position on the hand-held portion 11 may send the signals towards various directions out of the hand-held shell or receive the external signals from various directions. In this case, the signaling portion 101 has a wider signal receiving range and a wider signal sending range. In some embodiments, as shown in FIGS. 7 and 8, at least two signaling portions 101 are disposed. The at least two signaling portions 101 are respectively disposed on the bottom cover 13 and the hand-held portion 11,, enabling the oral care device 100 to have the wider signal receiving range and the wider signal sending range.

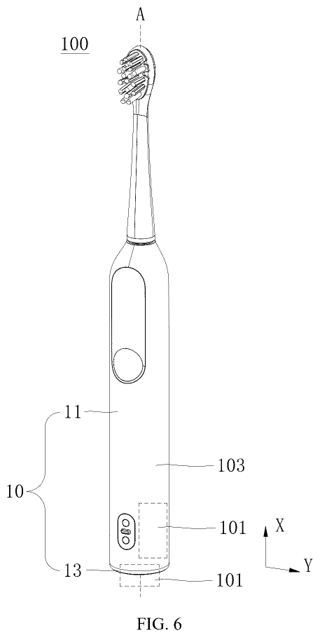

Further, as shown in FIG. 6, in some embodiments, the hand-held shell 10 further comprises a non-signaling portion 103. The non-signaling portion 103 is a portion that does not receive the external signals or send the signals. The non-signaling portion 103 may be connected to or isolated from the signaling portion 101. The non-signaling portion 103 may be disposed on the hand-held portion 11 or on the bottom cover 13. In some embodiments, the non-signaling portion 103 may be made of a material that is electrically insulated from the signaling portion 101. In some embodiments, the non-signaling portion 103 may be electrically connected to the signaling portion 101 to perform a different function. For example, the non-signaling portion 103 may be an electrically triggered button. When the non-signaling portion 103 detects the current, the electrically triggered button may control the oral care device 100 to start or stop. In some embodiments, as shown in FIG. 8, the material of the non-signaling portion 103 is generally different from the material of the signaling portion 101. When the material of the non-signaling portion 103 is different from the material of the signaling portion 101, the non-signaling portion 103 and the signaling portion 101 do not affect each other. In this way, turbulent waves are prevented, and quality of the signal transmission is not affected.

Specifically, in some embodiments, when the hand-held shell 10 is completely made of the metal, both the signaling portion 101 and the non-signaling portion 103 are made of the metal. The signaling portion 101 and the non-signaling portion 103 are made of different metallic materials. When both the signaling portion 101 and the non-signaling portion 103 are made of the metal, the non-signaling portion 103 may be made of an ordinary conductor material that does not interconvert the high-frequency current and the radio waves. Therefore, the non-signal portion 103 and the signal portion 101 do not interfere with each other, the turbulent waves are prevented, and quality of the signal transmission may not be affected.

Further, as shown in FIG. 3, in some embodiments, along the direction X of the center axis A of the hand-held shell 10, a distance H1 between the signaling portion 101 and the top end 111 of the hand-held portion 11 is not greater than ¼ of a length H0 of the hand-held shell 10. When the signaling portion 101 is disposed at a position where the distance H1 between the signaling portion 101 and the top end 111 of the hand-held portion 11 is less than ¼ of the length H0 of the hand-held shell 10, the signaling portion 101 is located on one side of the hand-held shell 10 that is closer to the top end 111 of the hand-held portion 11. In this case, the signaling portion 101 is disposed on a peripheral wall of the hand-held portion 11, and the signaling portion 101 is disposed at the one side of the hand-held shell 11 closer to the top end 111 of the hand-held portion 11. When the signaling portion 101 is disposed on the one side of the hand-held shell 10 closer to the top end 111 of the hand-held portion 11, the signaling portion 101 is misaligned from a position of the oral care device 100 held by a hand of a user. In this way, a signal transmitting and receiving path of the signaling portion 101 is prevented from being blocked when the user holds the oral care device 100. In some embodiments, along the direction X of the center axis A of the hand-held shell 10, a distance H2 between the signaling portion 101 and the bottom end 113 of the hand-held portion 11 is not greater than ¼ of the length H0 of the hand-held shell 10. When the signaling portion 101 is disposed at a position where the distance H2 between the signaling portion 101 and the bottom end 113 of the hand-held portion 11 is less than ¼ of the length H0 of the hand-held shell 10, the signaling portion 101 is located at one side of the hand-held shell 10 closer to the bottom end 113 of the hand-held portion 11. In this case, the signaling portion 101 is disposed on the bottom cover 13 and is located at the one side of the hand-held shell 10 closer to the bottom end 113 of the hand-held portion 11. When the signaling portion 101 is disposed on the one side of the hand-held shell 10 closer to the bottom end 113 of the hand-held portion 11, the signaling portion 101 is misaligned from the position of the oral care device 100 held by the hand of the user. In this way, the signal transmitting and receiving path of the signaling portion 101 is prevented from being blocked when the user holds the oral care device 100.

Furthermore, in some embodiments, the bottom cover 13 includes a blocking portion 131 and a connection portion 133. The blocking portion 131 is metallic, and the connection portion 133 is non-metallic. The blocking portion 131 extends from one side of the connection portion 133 close to the bottom end 113 of the hand-held portion 11 towards the interior of the hand-held portion 11. The connection portion 133 is connected to the blocking portion 131 and is disposed in the hand-held portion 11. The blocking portion 131 is substantially plate shaped. The blocking portion 131 blocks the opening of the bottom end 113 of the hand-held portion 11 to isolate internal structures of the oral care device 100 from the exterior of the oral care device, preventing water steam or dust from entering the oral care device 100. The connection portion 133 is connected to the hand-held portion 11 and prevents the hand-held portion 11 and the bottom cover 13 from being disengaged from each other, improving stability of the electrical connection between the electrical connector 40 and the signaling portion 101 on the blocking portion 131. In some embodiments, the connection portion 133 is substantially a hook structure or a plate-shaped structure that extends into the hand-held portion 11 and is connected to the hand-held portion 11, enabling the bottom cover 13 to be mounted on the hand-held portion 11. In some embodiments, the connection portion 133 is substantially a tubular structure having an internal cavity. The signaling portion 101 is disposed on the blocking portion 131. The electrical connector 40 abuts against the signaling portion 101 on the blocking portion 131. The connection portion 133 avoids the signaling portion 101 on the blocking portion 131. Since the connection portion 133 has poor electrical conductivity, the electrical connector 40, when being electrically connected to the signaling portion 101 on the blocking portion 131, needs to pass through or round the connection portion 133. In this way, quality of the signal transmission is improved.

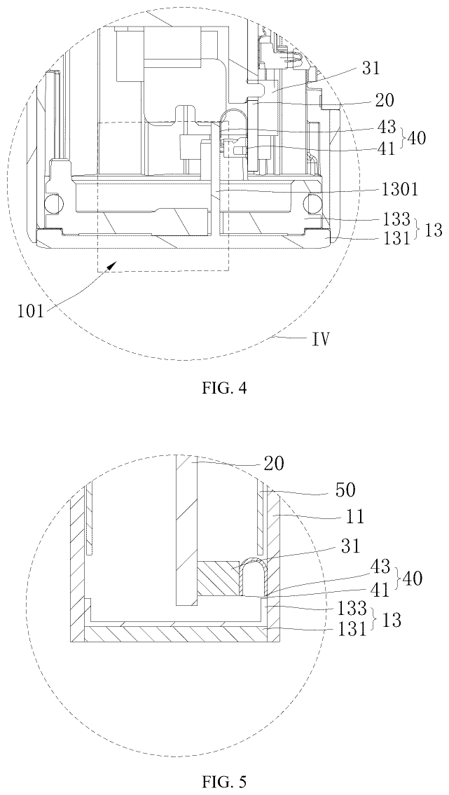

Specifically, as shown in FIG. 4, in some embodiments, the bottom cover 13 comprises an abutting piece 1301 that is protruding and extending from the bottom cover 13. The abutting piece 1301 is a conductive piece protruding from the bottom cover 13. In some embodiments, the abutting piece 1301 passes through or rounds the connection portion 133 to be directly connected to the blocking portion 131. In this case, the signaling portion 101 includes at least a portion of the abutting piece 1301 and the blocking portion 131. In some embodiments, the abutting piece 1301 is connected to the connection portion 133, and in this case, the signaling portion 101 includes only the abutting piece 1301. The first end of the electrical connector 40 is electrically connected to the communication module 31, and the second end of the electrical connector 40 abuts against the abutting piece 1301. Compared to the embodiment where the signaling portion 101 is disposed on the bottom cover 13, in this case, the abutting piece 1301 is disposed closer to the electrical connector 40. In this way, the electrical connector 40 is electrically connected to the bottom cover 13 through the abutting piece 1301, without extending for a long distance. Quality of the electrical contact between the electrical connector 40 and the bottom cover 13 is improved, and transmission of the signals is more stable.

As shown in FIGS. 1, 2, and 4, in some embodiments, the communication assembly 30 is substantially configured to send signals outwardly based on an instruction or to receive and read externa signals sent from the external device to the oral care device 100 to obtain an instruction. The communication assembly 30 include, but are not limited to, a WIFI module, a BLUETOOTH module, or a Zigbee, etc. The circuit board 20 is electrically connected to the communication assembly 30 to supply power to the communication assembly 30. In some embodiments, the communication module 31 of the communication assembly 30 is disposed on the circuit board 20 and is directly electrically connected to the circuit board 20. In some embodiments, as shown in FIG. 10, the communication module 31 is disposed on the signaling portion 101 of the hand-held shell 10 (located on the hand-held portion 11 or the bottom cover 13) and is indirectly electrically connected to the circuit board 20. The communication module 31 can transmit, via the electrical connector 40, the current or the guided waves to the signaling portion 101. Moreover, the communication module 31 can receive, via the electrical connector 40, the current or the guided waves transmitted from the signaling portion 101. In this way, the oral care device 100 is enabled to send the signals to the exterior or to receive the external signals sent from the external terminal or the cloud.

As shown in FIGS. 1, 2 and 4, in some embodiments, the electrical connector 40 is electrically connected to the communication module 31 and the signaling portion 101; or electrically connected to the circuit board 20, the communication module 31, and the signaling portion 101. The electrical connector 40 may be an independent conductive piece, such as a wire (as shown in FIG. 7), or a rigid or flexible circuit board 20 (as shown in FIG. 8) that is connected to the communication module 31 and the signaling portion 101. Structures of the electrical connector 40 are not limited herein. The electrical connector 40 includes the first end and the second end opposite to the first end. The first end 41 of the electrical connector 40 is electrically connected to the communication module 31, and the second end 43 of the electrical connector 40 is electrically connected to the signaling portion 101 of the hand-held shell 10.

In some embodiments, as shown in FIG. 5, the second end 43 of the electrical connector 40 is soldered to an inner wall of the signaling portion by copper leach or is electrically attached to the inner wall of the signaling portion 101 of the hand-held shell 10. In this case, the second end 43 of the electrical connector 40 and the inner wall of the signaling portion 101 of the hand-held shell 10 are fixedly connected to each other and are unable to be separated from each other. The electrical connector 40 and the signaling portion 101 are always electrically connected to each other. On the one hand, the electrical connector 40 cannot be easily fallen off from the inner wall of the signaling portion 101; and on the other hand, an electrical circuit connection between the electrical connector 40 and the signaling portion 101 is more stable, and intermittent disconnection does not occur. In some embodiments, the electrical connector 40 is an elastic piece, such as an elastic sheet or an elastic pin. The first end 41 of the electrical connector 40 is fixed to the circuit board 20 and is electrically connected to the communication module 31. The second end 43 of the electrical connector 40 forms a contact-type electrical connection with the inner wall of the signaling portion 101 of the hand-held shell 10. In this case, the second end 43 of the electrical connector 40 and the inner wall of the signaling portion 101 of the hand-held shell 10 are detachably connected to each other. The elastic electrical connector 40 is deformed or micro-deformed between the circuit board 20 and the communication module 31 and abuts against the communication module 31. In this way, the connection between the electrical connector 40 and the communication module 31 is more stable, and circuit interruption or poor contact is avoided.

As shown in FIGS. 2 and 3, in some embodiments, the oral care device 100 further includes an inner liner 50. The inner liner 50 is substantially a tubular structure disposed inside and connected to the hand-held portion 11. Material of the inner liner 50 includes, but is not limited to, a non-metallic material, such as plastic, silicone, or rubber. Compared to the hand-held portion 11 made of metal, the inner liner 50 can more securely connect to the structures disposed inside the oral care device 100, reducing wobbling and collision of the structures disposed inside the oral care device 100. In some embodiments, the inner liner 50 is integrally molded in the interior of the hand-held portion 11. In some other embodiments, the inner liner 50 comprises structures that are independently molded and are then mounted inside the hand-held portion 11. A size of an outer contour of any cross section of the inner liner 50 is not greater than a size of an inner contour of any cross section of the hand-held portion 11, enabling the inner liner 50 to be mounted inside the hand-held portion 11. Since the hand-held portion 11 is made of the metal, the structures inside the oral care device 100 are not easily fixed to the hand-held portion 11 made of the metal, and costs for manufacturing a fixation structure to the inside of the metal hand-held portion 11 may be high. The inner liner 50 that is non-metallic is configured to connect the internal structures of the oral care device 100 with the connection portion 133 of the bottom cover 13. On the one hand, the manufacturing costs of the oral care device 100 are reduced; and on the other hand, the internal structures of the oral care device 100 are prevented from shaking inside the hand-held portion 11, protecting the internal structures of the oral care device 100.

Further, as shown in FIG. 4, in some embodiments, the connection portion 133 of the bottom cover 13 is connected to the inner liner 50. The inner liner 50 that is non-metallic can be securely connected to the connection portion 133 that is non-metallic to enable the bottom cover 13 to be tightly connected to the hand-held portion 11 that is metallic. Material of the connection portion 133 may be the same as or different from material of the inner liner 50. The connection portion 133 and the inner liner 50 are connected to each other either by a non-removable means, such as hot melt or glue; or by a removable means, such as threaded connection, snap connection, or bolt connection, which are not limited herein. In some embodiments, the bottom cover 13 is connected to the hand-held portion 11. For instance, the connection portion 133 of the bottom cover 13 extends to the interior of the hand-held portion 11 and is connected to both the hand-held portion 11 and the inner liner 50. In another example, the connection portion 133 of the bottom cover 13 is only connected to the hand-held portion 11 and is separated from the inner liner 50.

As shown in FIGS. 1, 2, and 4, in some embodiments, the oral care device 100 further includes a movement assembly 60. The movement assembly 60 is mounted inside the hand-held shell 10 and is configured to support and allows the circuit board 20 and other structures of the oral care device 100 to mount thereon. The movement assembly 60 is disposed inside the hand-held portion 11, and in some embodiments, the movement assembly 60 is detachably mounted, by threaded connection, snap connection, or bolt connection, on the inner wall of the hand-held shell 10. In some embodiments, the movement assembly 60 is fixed to the inner wall of the hand-held shell 10 by hot melting, glue, or soldered connection. When only a portion of the communication module 31 is electrically connected to the circuit board 20, the portion of the communication module 31 is fixed to the movement assembly 60. The movement assembly 60 is configured to mount the communication module 31.

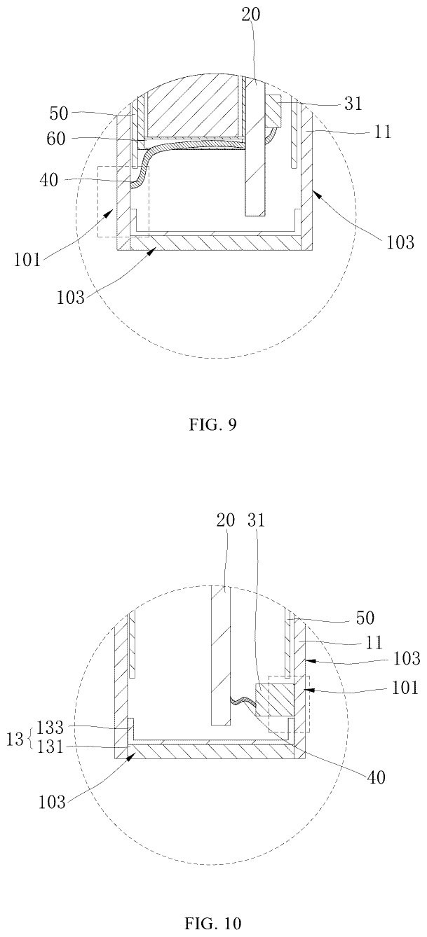

Further, as shown in FIG. 9, in some embodiments, the movement assembly 60 is disposed inside and connected to the inner liner 50. The electrical connector 40 passes through and/or rounds the inner liner 50 to abut against the signaling portion 101. The signaling portion 101 may be disposed either on the bottom cover 13 or on the hand-held portion 11, which is not limited herein. When an inner peripheral wall of the inner liner 50 and an outer peripheral wall of the movement assembly 60 are connected to each other, the movement assembly 60 is mounted inside the inner liner 50 and does not shake or rotate violently inside the inner liner 50. In this way, stability of the connection between structures disposed inside the oral care device 100 is improved. Since an outer shell of the inner liner 50 and an outer shell of the movement assembly 60 are made of non-conductive and non-metallic materials, the electrical connector 40 needs to pass through and/or rounds the outer shell of the inner liner 50 and the outer shell of the movement assembly 60 to allow the communication module 31 to be always electrically connected to the signaling portion 101.

Specifically, in some embodiments, the circuit board 20 further includes a protruding portion 21, and the protruding portion 21 is formed by a portion of the circuit board 20 extending, along the direction X of the center axis A of the hand-held shell 10, towards the bottom cover 13. The protruding portion 21 protrudes towards the bottom cover 13 with respect to the movement assembly 60. That is, the protruding portion 21 and the movement assembly 60 are staggered to each other and do not overlap with each other along the direction Y perpendicular to the center axis A of the hand-held shell 10. Both of the communication module 31 and the electrical connector 40 are disposed on the protruding portion 21. Compared to the embodiment where the circuit board 20 is not provided with the protruding portion 21, the communication module 31 and the electrical connector 40 disposed on the protruding portion 21 are staggered from the movement assembly 60. In this way, the communication module 31 and the electrical connector 40 are enabled to be partially extending around the movement assembly 60 and to be disposed closer to the signaling portion 101 of the bottom cover 13 and/or the signaling portion 101 at the peripheral wall of the hand-held shell 11. On the one hand, the movement assembly 60 is prevented from blocking a signal propagation path that the signal transceiver receives and/or sends the signal. On the other hand, the protruding portion 21 extending toward the bottom cover 13 is further configured to enable the communication module 31 and the electrical connector 40 disposed on the protruding portion 21 to be disposed closer to the signaling portion 101. Therefore, the efficiency of the signal transmission is improved, and the inner structures of the oral cavity care device 100 are disposed in a more compact manner.

In summary, in the oral care device 100 of the present disclosure, after the communication module 31 is electrically connected to the signaling portion 101 of the hand-held shell 10, the communication module 31 and the signaling portion 101 of the hand-held shell 10 jointly form the signal transceiver. In this case, the signals sent by the signal transceiver are directly transmitted to the exterior of the hand-held shell 10 via the signaling portion 101 of the hand-held shell 10, and the external signals sent by the external device are directly received by the signaling portion 101 of the hand-held shell 10. The signals do not need to penetrate the hand-held shell 10 during the transmission, and therefore, the loss of the signals is reduced, and the transmission efficiency of the signals is improved.

In the specification of the present disclosure, reference to the terms “some embodiments”, “in an example”, “exemplarily”, and so on, mean that specific features, structures, materials, or characteristics described in the embodiments or examples are included in at least one of embodiments or examples of the present disclosure. In the present specification, schematic expressions of the above terms do not necessarily refer to a same embodiment or example. Moreover, the specific features, structures, materials, or characteristics may be combined in any one or more of the embodiments or examples in any suitable manner.

What is claimed is:

1. An oral care device, comprising:
a hand-held shell;
a circuit board;
a communication assembly, and
an electrical connector;
wherein the hand-held shell defines a signaling portion; the circuit board is disposed inside the hand-held shell; the communication assembly comprises a communication module, the communication module is disposed on and electrically connected to the circuit board; the electrical connector is disposed inside the hand-held shell, the communication module is electrically connected to the signaling portion of the hand-held shell via the electrical connector, the signaling portion of the hand-held shell and the communication module jointly form a signal transceiver, and the signal transceiver is configured to send signals to an exterior of the hand-held and/or receive external signals from the exterior of the hand-held shell.

2. The oral care device according to claim 1, wherein the hand-held shell comprises a hand-held portion and a bottom cover, the bottom cover is mounted to a bottom end of the hand-held portion, the signaling portion is disposed on at least one of the hand-held portion and the bottom cover, and the hand-held portion is made of metal.

3. The oral care device according to claim 1, wherein a first end of the electrical connector is fixed to the circuit board and is electrically connected to the communication module, and a second end of the electrical connector is electrically connected to an inner wall of the signaling portion of the hand-held shell.

4. The oral care device according to claim 3, wherein the electrical connector is an elastic piece, and the inner wall of the signaling portion is capable of contacting with the electrical connector for being electrically connected to the electrical connector.

5. The oral care device according to claim 3, wherein the hand-held shell comprises a hand-held portion and a bottom cover, the bottom cover is mounted to a bottom end of the hand-held portion, the signaling portion is defined on the bottom cover, and the electrical connector is electrically connected to the signaling portion on the bottom cover.

6. The oral care device according to claim 5, wherein the signaling portion comprises an abutting piece protruded and extended from the bottom cover, and the electrical connector abuts against the abutting piece.

7. The oral care device according to claim 5, wherein the bottom cover comprises a blocking portion and a connection portion, the blocking portion is metallic, the connection portion is non-metallic, the blocking portion is configured to block an opening at the bottom end of the hand-held portion, the signaling portion is disposed at the blocking portion, and the electrical connector abuts against the signaling portion disposed at the blocking portion;
wherein the connection portion is connected to the blocking portion and is disposed inside the hand-held portion, and the connection portion is disposed avoiding the signaling portion disposed at the blocking portion.

8. The oral care device according to claim 7, wherein the oral care device further comprises a inner liner, the inner liner is non-metallic, the inner liner is disposed inside and connected to the hand-held shell, and the connection portion is connected to the inner liner.

9. The oral care device according to claim 5, wherein the bottom cover comprises a blocking portion and a connection portion, the blocking portion is metallic, the connection portion is non-metallic, the blocking portion is configured to block an opening at the bottom end of the hand-held portion, and the connection portion is connected to the blocking portion and is disposed inside the hand-held portion;
wherein an abutting piece is protruded and extended from the bottom cover, the abutting piece passes through or rounds the connection portion to be connected to the blocking portion, the signaling portion comprises the abutting piece and the blocking portion, the electrical connector abuts against the blocking portion and the abutting piece, and the connection portion avoids the signaling portion disposed at the blocking portion.

10. The oral care device according to claim 3, wherein the oral care device further comprises a movement assembly disposed inside the hand-held shell, and the circuit board has a protruding portion;
wherein with respect to the movement assembly, the protruding portion protrudes towards the bottom cover along a direction of a center axis of the hand-held shell, and the communication module and the electrical connector are disposed on the protruding portion.

11. The oral care device according to claim 4, wherein the hand-held shell comprises a hand-held portion and a bottom cover, the bottom cover is mounted to a bottom end of the hand-held portion, the signaling portion is disposed on the hand-held portion, and the electrical connector is electrically connected to the signaling portion disposed on the hand-held portion.

12. The oral care device according to claim 11, wherein the oral care device further comprises a inner liner and a movement assembly, the inner liner is non-metallic, and the inner liner is disposed inside and connected to the hand-held portion;
the movement assembly is disposed inside and connected to the inner liner, and the electrical connector passes through and/or rounds the inner liner to abut against the signaling portion.

13. The oral care device according to claim 1, wherein the electrical connector comprises at least one of a conductive wire and a flexible circuit board, a first end of the electrical connector is electrically connected to the communication module, and a second end of the electrical connector is soldered to or attached to an inner wall of the signaling portion of the hand-held portion to be electrically connected to the signaling portion.

14. The oral care device according to claim 1, wherein the signaling portion is made of antenna material.

15. The oral care device according to claim 1, wherein the hand-held shell further comprises a non-signaling portion, the signaling portion is made of antenna material, and material of the non-signaling portion is different from that of the signaling portion.

16. The oral care device according to claim 12, wherein the hand-held shell is made of metal, the signaling portion and the non-signaling portion are made of different metal materials.

17. The oral care device according to claim 1, wherein a distance between the signaling portion and a top end of the hand-held shell is not greater than ¼ of a length of the hand-held shell; or
a distance between the signaling portion and a bottom end of the hand-held shell is not greater than ¼ of the length of the hand-held shell.

18. An oral care device, comprising:
a hand-held shell;
a communication assembly; and
an electrical connector;
wherein the hand-held shell defines a signaling portion, the communication assembly is disposed inside the hand-held shell, the communication assembly comprises a communication module; electrical connector is disposed inside the hand-held shell, the communication module is electrically connected to the signaling portion of the hand-held shell via the electrical connector, the signaling portion of the hand-held shell and the communication module jointly forms a signal transceiver, and the signal transceiver is configured to send signals to an exterior of the hand-held shell and/or to receive signals from the exterior of the hand-held shell.

19. The oral care device according to claim 18, wherein the hand-held shell comprises a hand-held portion and a bottom cover, the bottom cover is mounted to a bottom end of the hand-held portion, the signaling portion is disposed on at least one of the bottom cover and the hand-held portion, and the electrical connector abuts against the signaling portion;
wherein the communication module is disposed on the signaling portion.

20. The oral care device according to claim 18, wherein the oral care device further comprises a circuit board;
wherein the communication module is electrically connected to the circuit board, the electrical connector is an elastic piece, a first end of the electrical connector is fixed to the circuit board and electrically connected to the communication module, and a second end of the electrical connector contacts an inner wall of the signaling portion of the hand-held shell to be electrically connected to the signaling portion or
the electrical connector comprises at least one of: a conductive wire and a flexible circuit board; the first end of the electrical connector is electrically connected to the communication module, and the second end of the electrical connector is soldered to or attached the inner wall of the signaling portion of the hand-held shell to be electrically connected to the signaling portion.
